(19) United States
(12) Patent Application Publication
(10) Pub. No.: US 2006/0265458 A1
(43) Pub. Date: Nov. 23, 2006

(54) System and method for selecting and managing files

(76) Inventors: William C. Aldrich, San Francisco, CA (US); Suzanne Ginsburg, San Francisco, CA (US); Jeffrey C. Stoddard, Burlingame, CA (US); Scott Hartley, Castro Valley, CA (US)

Correspondence Address: MORRISON & FOERSTER LLP, 755 PAGE MILL RD, PALO ALTO, CA, 94304-1018, US

(21) Appl. No.: 11/202,670

(22) Filed: Aug. 12, 2005

Related U.S. Application Data
(60) Provisional application No. 60/683,216, filed on May 20, 2005.

(51) Int. Cl. G06F 15/16

(52) U.S. Cl. 709/206

(57) ABSTRACT

According to various aspects and examples described herein, systems and methods for selecting files for transfer via email are provided. In one example, a file selection interface is provided for selecting a file for transfer (e.g., embedding or attaching to an email) within a webmail environment. The file selection interface includes logic for displaying local files stored with a computer and remote files associated with a remote source, wherein the local files and remote files may be selected for transfer with an email message, and logic for initiating a process for embedding or attaching a selected file from the displayed local and remote files to the email message. The remote sources may include servers, such as online photo storage accounts, as well as files accessible through an internet search of at least one online sources.

### CROSS-REFERENCE TO RELATED APPLICATIONS

The present application claims the benefit of earlier filed U.S. Provisional Application No. 60/683,216, entitled “System and Method for Selecting and Managing Files” filed on May 20, 2005, which is incorporated by reference as if fully set forth herein.

### BACKGROUND

1. Field

The present invention relates generally to systems and methods for selecting and managing files, and in one aspect to selecting and managing image files for electronic mail transmission.

2. Background

Currently, image file integration into webmail-based applications is limited. The current mechanism to receive and share image files using webmail applications is as attachments, which is often cumbersome for webmail users. There are numerous drawbacks associated with this process of file sharing, including the inability or difficulty to attach remotely located image files and the inability or difficulty of the recipient to select which files to download. This is because typical webmail applications only allow a user to share image files which are stored locally. Moreover, files which are to be shared (e.g., emailed) generally must be uploaded/downloaded in their entirety, without providing the recipient with options as to which image files are to view and/or retrieve.

Accordingly, there is a need for an improved system and method which overcomes one or more of the aforementioned drawbacks by improving the integration between electronic mail and file selection and management.

### BRIEF SUMMARY

According to various aspects and examples described herein, systems and methods for selecting files for transfer via email are provided. In one example, a file selection interface is provided for selecting a file for transfer within an email environment. The file selection interface comprising logic for displaying local files stored with a local source (e.g., a user computer) and remote files associated with a remote source (e.g., a server or online storage account), and logic for enabling the selection of at least one file of the displayed local files and remote files for transfer with an email message. The system further includes logic for initiating a process for transferring the at least one file selected with the email message. The local files and remote files are displayed with a single graphical user interface, thereby allowing a user to embed or attach files, e.g., image files, from local and remote sources with reduced complexity. The remote sources may include servers, such as online photo storages, as well as files accessible through an internet search of at least one online sources.

According to another aspect a method for selecting files for transfer is provided. In one example, the method includes displaying local files stored with a local source and remote files associated with a remote source within a file selection interface, selecting one of the local files and remote files for transfer with an email message, and initiating a process for embedding or attaching the selected file to the email message.

According to another aspect a computer readable medium is provided. In one example, the computer readable medium is encoded with computer program code for displaying a file selection interface, the file selection interface displaying local files stored with a local source and remote files associated with a remote source, wherein the local files and remote files may be selected for transfer with an email message. The computer readable medium further including program code for initiating a process for embedding or attaching a selected file from the displayed local files and remote files to the email message.

Other aspects, features, and techniques of the invention will be apparent to one skilled in the relevant art in view of the following detailed description.

### BRIEF DESCRIPTION OF THE DRAWINGS

FIG. 1 depicts one embodiment of a system level diagram showing the interconnectivity of one or more aspects of the invention;

FIG. 2 depicts one embodiment of a system level diagram of a computer system consistent with the principles of the invention;

FIG. 3A depicts a flow diagram for how a user may interact with one or more aspects of the invention, according to one embodiment;

FIGS. 3B-3D are screenshots showing various aspects of the invention, according to one or more embodiments;

FIG. 4A is a flow diagram depicting how electronic mail and image file selection may be more tightly integrated, according to one embodiment;

FIGS. 4B-4C are screenshots of various graphical user interface screens usable to implement one or more aspects of the invention;

FIGS. 5A-5G are various embodiments of graphical user interface screenshots illustrating one or more aspects of the invention; and

FIG. 6 is one embodiment of a screenshot of a partially completed electronic mail message, consistent with the principles of the invention.

### DETAILED DESCRIPTION OF EXEMPLARY EMBODIMENTS

Systems and methods for selecting and managing files are disclosed. The following description is presented to enable a person of ordinary skill in the art to make and use the various examples. Descriptions of specific techniques and applications are provided only as examples. Various modifications to the examples described herein will be readily apparent to those of ordinary skill in the art, and the general principles defined herein may be applied to other examples and applications without departing from the spirit and scope of the inventions. Moreover, in the following description, numerous details are set forth for the purpose of explanation; however, one of ordinary skill in the art will recognize that certain aspects of the invention may be practiced without the use of these specific details. In other instances, well-known structures and devices are shown in block diagram form in order not to obscure the description of the invention with unnecessary detail. Thus, the appended claims are not intended to be limited to the examples described and shown herein, but are to be accorded the widest scope consistent with the principles and features disclosed herein.

One aspect of the invention includes providing a system for integrating the composition of electronic mail with the sharing of electronic files, particularly image files. In one example, an operating system module, which may be installed on a user computer, generates a file selection interface, characterized by a graphical user interface, to enable a user to select files from both local and remote sources when attaching or embedding files into an email. In one embodiment, this module is a Windows™ module which provides seamless access to both locally and remotely stored files. In another embodiment, or in addition to the previous embodiments, the graphical user interface enables users to navigate remotely-located file sources as if they were local directories. In still a further embodiment, the same graphical user interface is used to embed/attach files from a local storage device, as well as from a remote online account.

Another aspect includes presenting the graphical user interfaces referenced above in a webmail environment using an Internet browser, such as Windows Internet Explorer™. In this embodiment, a user accesses a webmail account using an Internet browser. The file selection interface may be integrated with the operating system and/or the Internet browser. The webmail account may then be used to compose an email message in a webmail environment without the use of an application program other than the browser itself. Users may select and embed image and non-image files from both local and remote locations using their web browser and the same graphical user interface, as described above.

In another embodiment, the invention may further provide the user with tools for editing and formatting image files which have been embedded into an email message, which in one embodiment is also performed using an Internet browser in a webmail environment.

Another aspect of the invention is to enable an email recipient to selectively download full image files from an email by selecting from among the individual thumbnails embedded in the email. In one embodiment, an ActiveX control reference is used to link the embedded thumbnail to a remote online account which stores the corresponding full image file. In another embodiment, the full image file may also be embedded into the body of the email.

Image thumbnails and corresponding ActiveX control references may be embedded into an email in a webmail environment using a web browser. In one embodiment, the recipient receiving the email does so using a web browser and a webmail account. By clicking on or otherwise selecting from among the embedded thumbnails, the email recipient may effectively download only select files contained in the received email. In one embodiment, selected files may be downloaded from an online account located on a remote server. In yet another embodiment, an email recipient may choose to download the selected files from the sender's online account to a remote online account associated with the email recipient.

In accordance with the practices of persons skilled in the art of computer programming, the invention is described below with reference to symbolic representations of operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The program or code segments can be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

As discussed herein, a “computer” or “computer system” is a product including circuitry capable of processing data. The computer system may include, but is not limited to, general purpose computer systems (e.g., server, laptop, desktop, palmtop, personal electronic devices, etc.), personal computers (PCs), hard copy equipment (e.g., printer, plotter, fax machine, etc.), banking equipment (e.g., an automated teller machine), and the like. In addition, a “communication link” refers to the medium or channel of communication. The communication link may include, but is not limited to, a telephone line, a modem connection, an Internet connection, an Integrated Services Digital Network (“ISDN”) connection, an Asynchronous Transfer Mode (ATM) connection, a frame relay connection, an Ethernet connection, a coaxial connection, a fiber optic connection, satellite connections (e.g. Digital Satellite Services, etc.), wireless connections, radio frequency (RF) links, electromagnetic links, two way paging connections, etc., and combinations thereof.

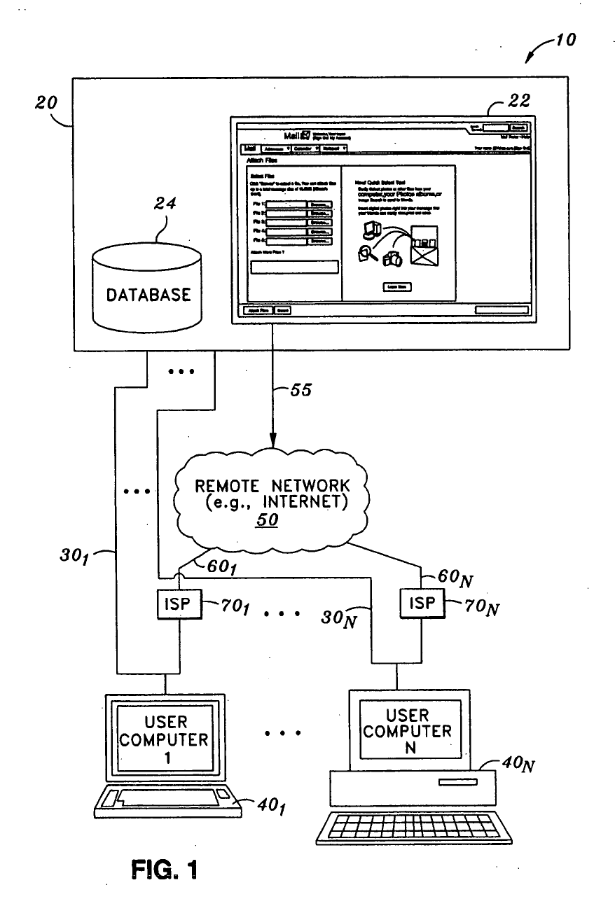

FIG. 1 shows a system block diagram of one embodiment of an information distribution system 10 in which the system and method of the invention may be used. In the embodiment of FIG. 1, system 10 comprises a remote server 20 that may be connected over one or more communications links 30₁-30_{N} (“30”) to one or more user computer systems 40₁-40_{N} (“40”). The remote server 20 may include computer readable instructions for generating and displaying one or target websites 22 to the user computers 40. In one embodiment, the remote server 20 may further include one or more databases 24 for storing data such as, for example, user data and/or target website 22 data. While for brevity remote server 20 is referred to in the singular, it should equally be appreciated that remote server 20 may be comprised of a plurality of individual computers or servers.

Remote server 20 may further be connected to a remote network 50 (e.g., the Internet) or a remote site (e.g., a satellite, which is not shown in FIG. 1) via communication link 55. The remote network 50 or remote site may be used to allow the remote server 20 to provide a wider variety of computer software, content, etc. to the one or more user computers 40. In addition, user computers 40 may be coupled to the remote network via communication link 60₁-60_{N} and internet service provider (ISP) 70₁-70_{N}.

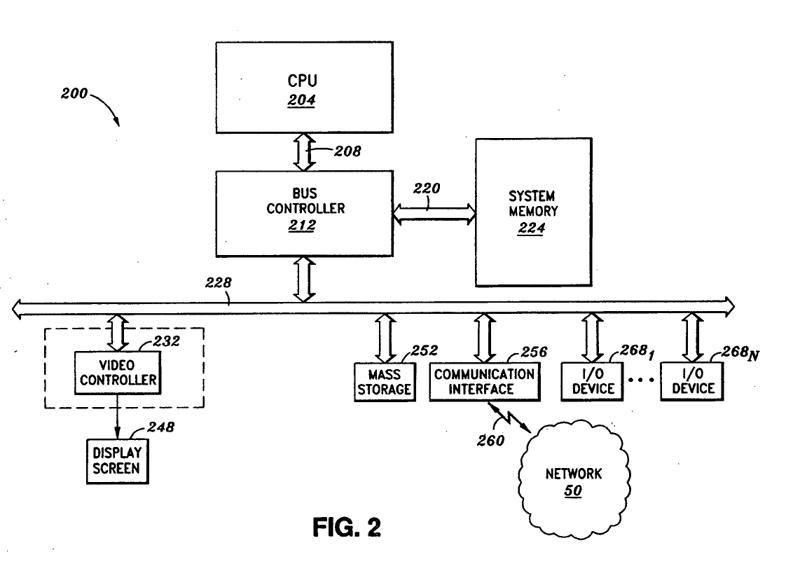

Referring to FIG. 2, depicted is one embodiment of the type of computer system which may comprise the one or more user computers 40 of FIG. 1. In particular, computer system 200 comprises a processor or a central processing unit (CPU) 204, which may include an arithmetic logic unit (ALU) for performing computations, a collection of registers for temporary storage of data and instructions, and a control unit for controlling operation for the system 200. In one embodiment, the CPU 204 includes any one of the x86, Pentium™ class microprocessors as marketed by Intel™. Corporation, microprocessors as marketed by AMD™, or the 6×86MX microprocessor as marketed by CyriX™ Corp. In addition, any of a variety of other processors, including those from Sun Microsystems, MIPS, IBM, Motorola, NEC, Cyrix, AMD, Nexgen and others may be used for implementing CPU 204. Moreover, the CPU 204 is not limited to microprocessors but may take on other forms such as microcontrollers, digital signal processors, reduced instruction set computers (RISC), application specific integrated circuits, and the like. Although shown with one CPU 204, it should equally be appreciated that computer system 200 may alternatively include multiple processing units.

The CPU 204 is coupled to a bus controller 212 by way of a CPU bus 208. The bus controller 212 may include a memory controller integrated therein, although the memory controller may be external to the bus controller 212. In one embodiment, the system memory 224 may be coupled to the bus control 212 via a memory bus 220, where the system memory 224 may include synchronous dynamic random access memory (SDRAM). System memory 124 may optionally include any additional or alternative high speed memory device or memory circuitry. The bus controller 212 is coupled to a system bus 228 that may be a peripheral component interconnect (PCI) bus, Industry Standard Architecture (ISA) bus, etc. Coupled to the system bus 228 are a graphics controller, a graphics engine or a video controller 232, a mass storage device 252, a communication interface device 256, one or more input/output (I/O) devices 268₁-268_{N}. The video controller 232 may be coupled to a video memory and video BIOS, all of which may be integrated onto a single card or device. The video memory may be used to contain display data for displaying information on the display screen 248, and the video BIOS may include code and video services for controlling the video controller 232. In another embodiment, the video controller 232 may be coupled to the CPU 204 through an advanced graphics port (AGP) bus (not shown).

The mass storage device 252 may include (but not be limited to) a hard disk, floppy disk, CD-ROM, DVD-ROM, tape, high density floppy, high capacity removable media, low capacity removable media, solid state memory device, etc., and combinations thereof. The mass storage device 252 may further include any other mass storage medium. The communication interface device 256 may include a network card, a modem interface, etc. for accessing network 50 via communications link 260. The I/O devices 268₁-268_{N} include a keyboard, mouse, audio/sound card, printer, and the like. The I/O device 268₁-268_{N} may be a disk drive, such as a compact disk drive, a digital disk drive, a tape drive, a zip drive, a jazz drive, a digital video disk (DVD) drive, a solid state memory device, a magneto-optical disk drive, a high density floppy drive, a high capacity removable drive, a low capacity media device, and/or any combination thereof.

Computer system 200 may further include system firmware, such as system BIOS, for controlling, among other things, hardware devices in the computer system 200. The system firmware may include ROM and/or flash (or EEPROM) memory.

As is familiar to those skilled in the art, the computer system 200 may further include an operating system (OS) and at least one application program, which in one embodiment, are loaded into system memory 224 from mass storage device 252. The OS may include any type of OS including, but not limited or restricted to, DOS, Windows, Unix, Linux, Xenix, etc. The operating system generally includes a set of one or more programs which control the operation of computer system 200 and the allocation of resources. The application program generally includes a set of one or more software programs that performs a task desired by the user.

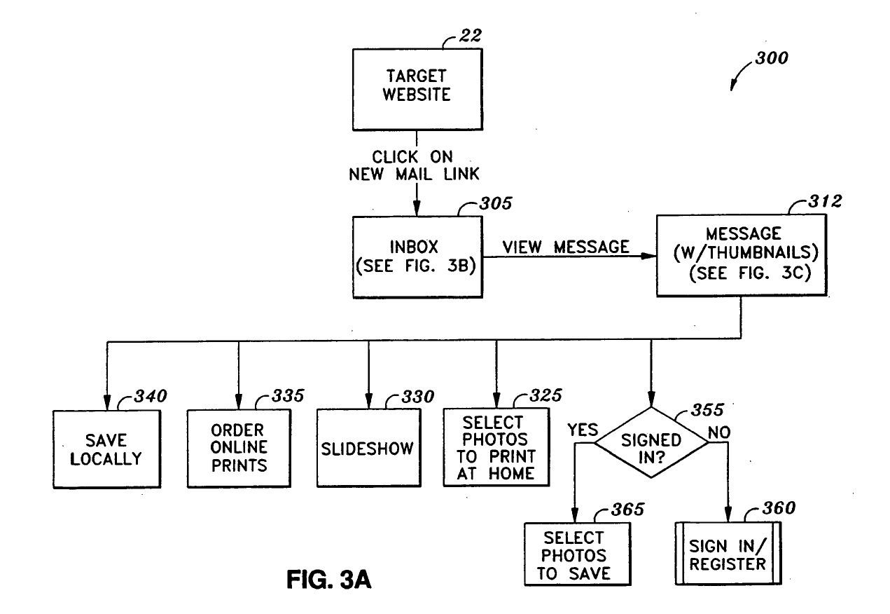

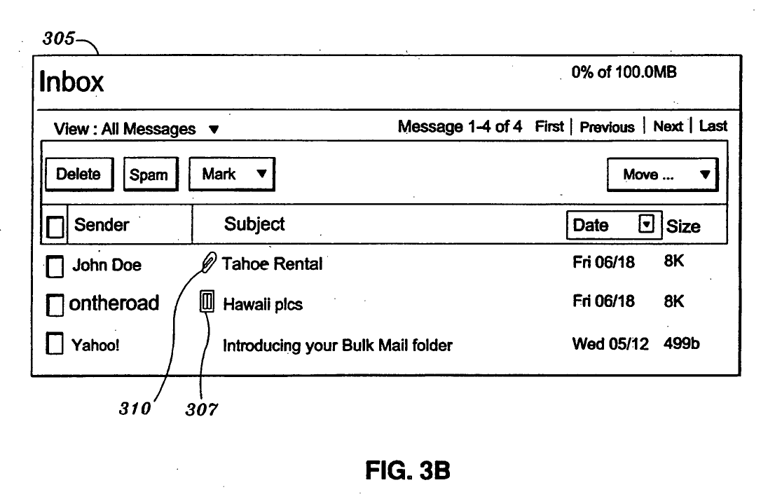

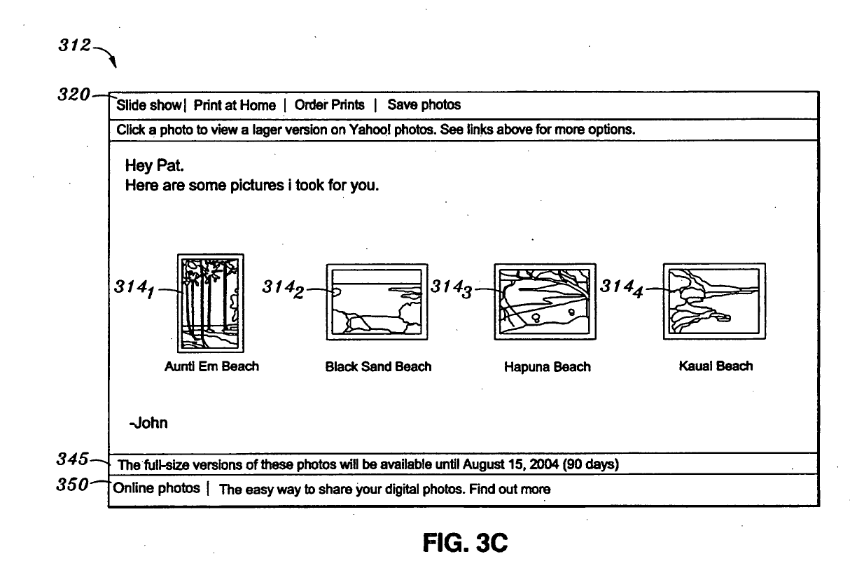

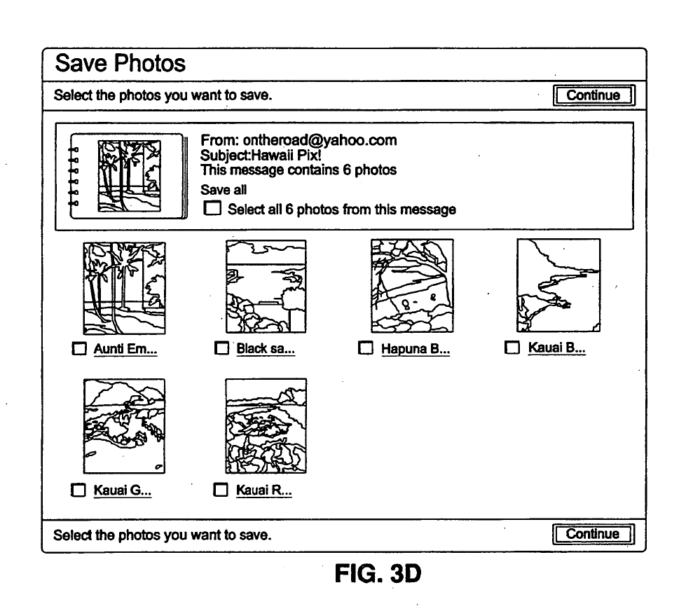

Referring now to FIG. 3A, depicted is a flow diagram for one example of how a user may receive and/or organize electronic mail containing image files, which may be used with various aspects described herein. In particular, process 300 begins with a user accessing target website 22. As previously described, a user computer 40 coupled to network 50 may be used to access the target website 22 from server 20. Thereafter, from target website 22 a user may then select a hypertext link to access their webmail inbox 305. It should be appreciated that the user may be prompted to log in to a corresponding user account prior to being able to access inbox 305. In another embodiment, target website 22 may include text or an icon indicating that the user has new mail in its electronic mail inbox 305. One embodiment of a screenshot for inbox 305 is shown as FIG. 3B. However, it should of course be appreciated that numerous other embodiments and configurations may be used for inbox 305.

As shown in FIG. 3B, electronic mail may be presented in a web browser in a list fashion arranged by sender, subject or date. If an email contains an embedded image attachment, the image file icon 307 may be displayed. If, on the other hand, an email contains a traditional file attachment, the typical attachment icon 310 may be displayed instead. Where an email contains both embedded and traditional attachments, either or both of the image file icon 307 and attachment icon 310 may similarly be displayed.

From inbox 305, once a user selects to view a particular email, process 300 of FIG. 3A may then open and display the contents of the chosen email message, such as message 312 of FIG. 3C. FIG. 3C depicts one embodiment of a screenshot of message 312, where the message contains embedded image thumbnails 314₁-314₄. In one embodiment, the full image files which correspond to thumbnails 314₁-314₄ are not downloaded as part of message 312, but are rather maintained on server 20, or some other remote online account. In this embodiment, the thumbnail data and link information to the full image files are all that are downloaded to the user computer 40. For larger image files, this would decrease the amount of time required to download message 312, thereby improving the efficiency of image file sharing.

Message 312 may also contain an options menu 320. In particular, the options menu 320 includes options for printing the image files locally on a physical printer (325), for presenting the photos as a slideshow for online ordering of prints (330), for ordering online prints (335), and for locally saving the full image files (340). In one embodiment, the full image files may be downloaded and stored locally on user computer 40 by selecting the “save photos” option.

In addition to the options menu 320, message 312 may also contain additional information 345 relating to the image files. For example, in FIG. 3C information 345 indicates that availability of the full image files which correspond to thumbnails 314₁-314₄. Finally, message 312 may further include online options 350 for storing the full image files on, or otherwise making the image files accessible to, a remote server. In one embodiment, the remote location may be a specialized photo storage account, such as Yahoo! Photos. Using such a storage account, users may be able to upload and share image files that were sent to them. For example, from Yahoo! Photos a logged-in user may be able to view, download and/or print the uploaded image files.

Referring back to FIG. 3A, if a user selects the online storage option 350, process 300 may continue to block 355 where a determination is made as to whether the user is logged in to the online photo storage account (e.g., Yahoo! Photos). If not, the user may be prompted to log in at block 360. Once the user is logged in, process 300 continues to block 365 where the user is then permitted to select the photos to save to their online photo storage account. FIG. 3D depicts a screenshot of one embodiment for how a user may select, directly from an email, which image files should be uploaded to their photo storage account. A save confirmation screen may then be presented to the user indicating that the selected photos were successfully uploaded. In another embodiment, the user may also be presented with a variety of options as to how the uploaded photos should be organized. For example, a user may be prompted to create a virtual album containing photos having some common characteristic (e.g., same theme, trip, etc.).

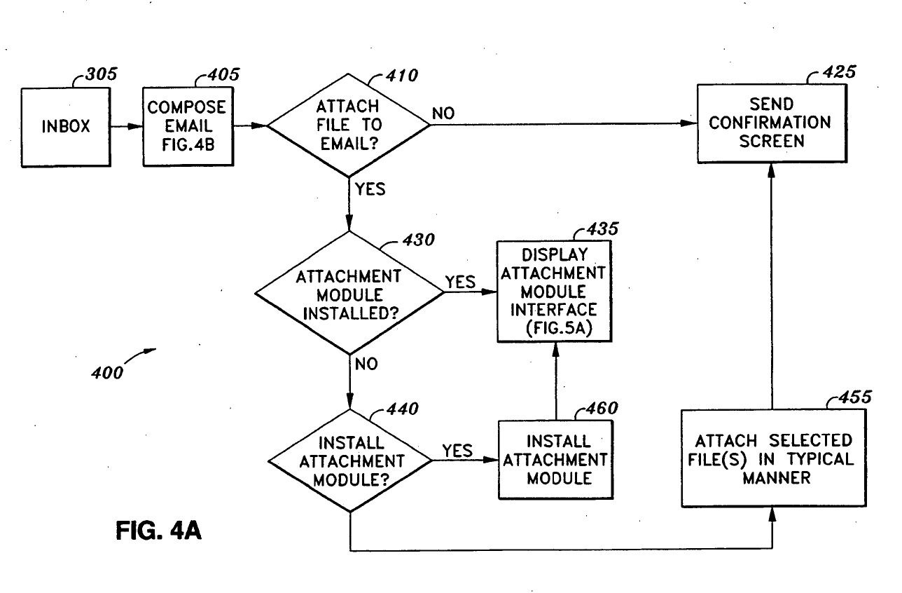

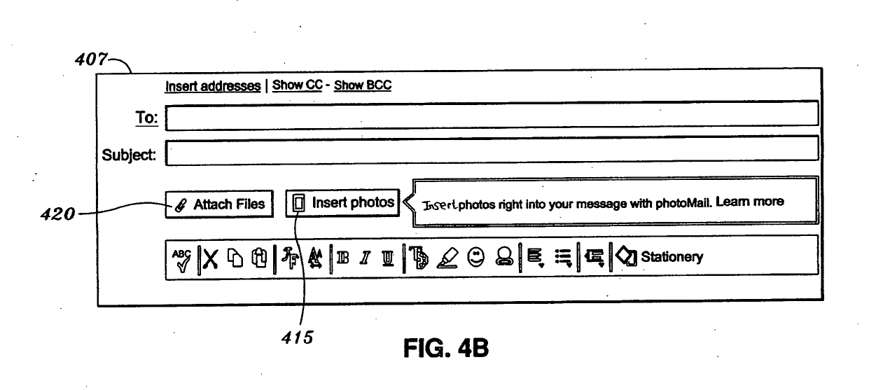

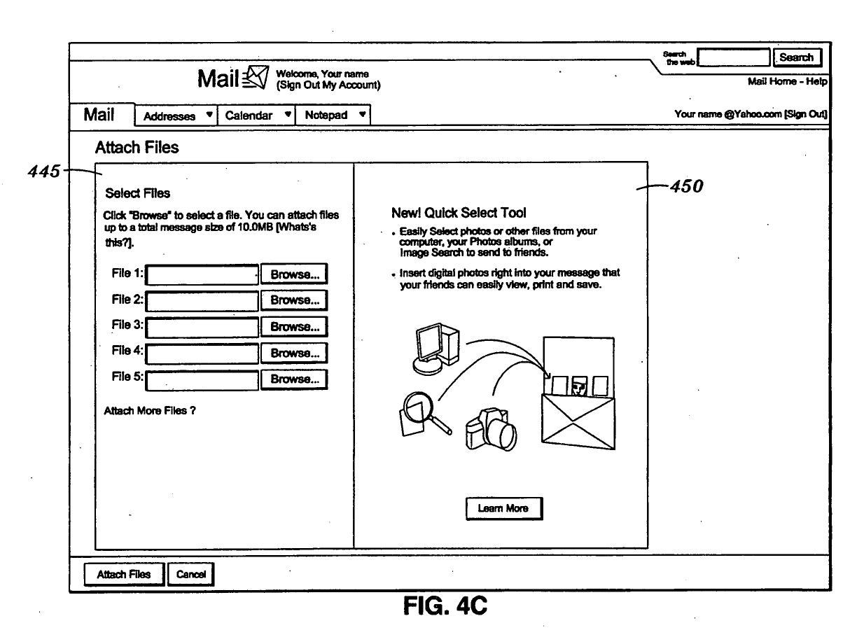

Referring now to FIG. 4A, depicted is a process 400 for how a user may select an image file that is to be included as part of an electronic mail message. In addition to enabling users to select photos from their local computer, e.g., a personal desktop computer system, this aspect of the invention will enable users to access image files from a remote source, e.g., an online account (e.g., Yahoo! Photos or the like) or via an internet search, to be embedded in an email message.

Process 400 begins with a user accessing target website 22 (see FIG. 3A). As previously described with respect to FIG. 1, a user computer 40 coupled to network 50 may be used to access the target website 22 from server 20. Thereafter, from target website 22 a user may then select a hypertext link to access a webmail inbox, such as previously-described inbox 305. It should be appreciated that the user may be prompted to log in to a corresponding user account prior to being able to access inbox 305. In another embodiment, target website 22 may include a welcome screen with an icon dedicated to electronic mail functionality.

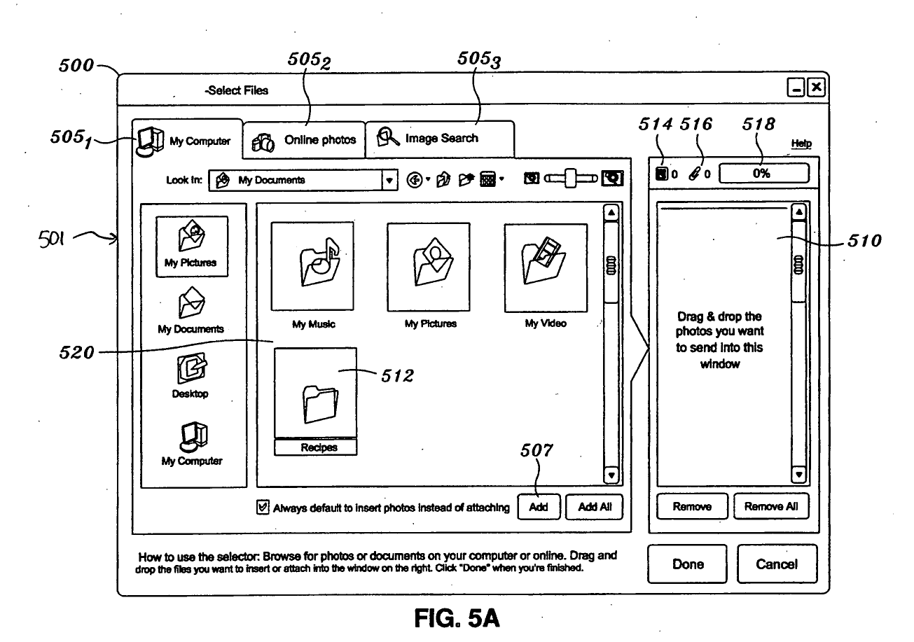

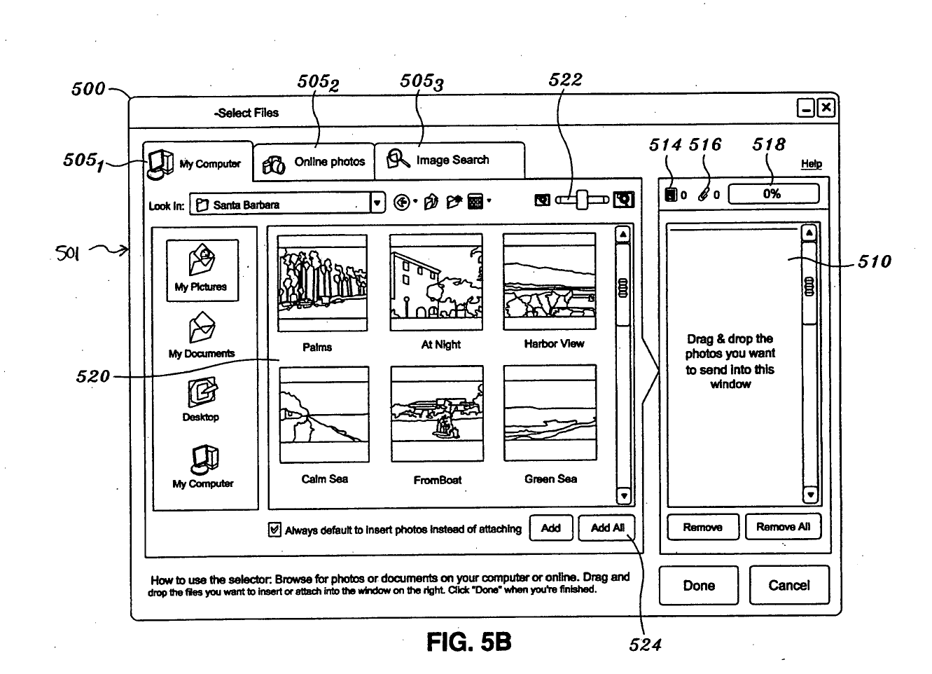

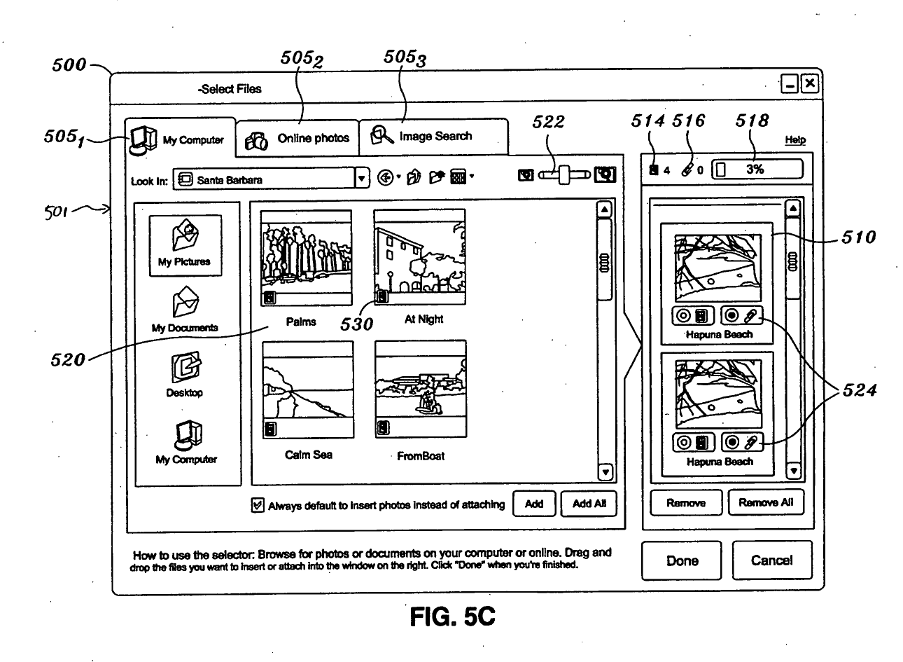

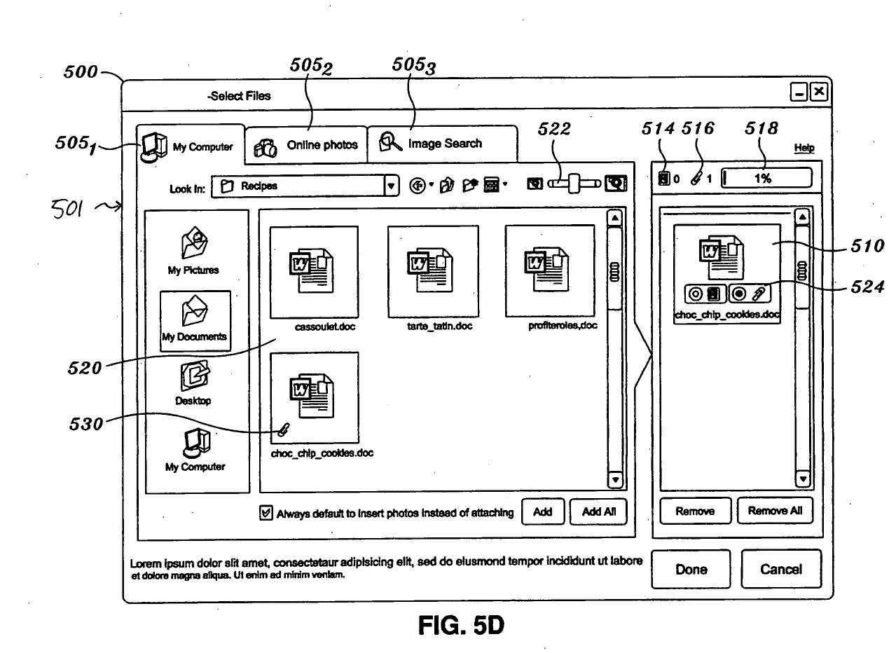

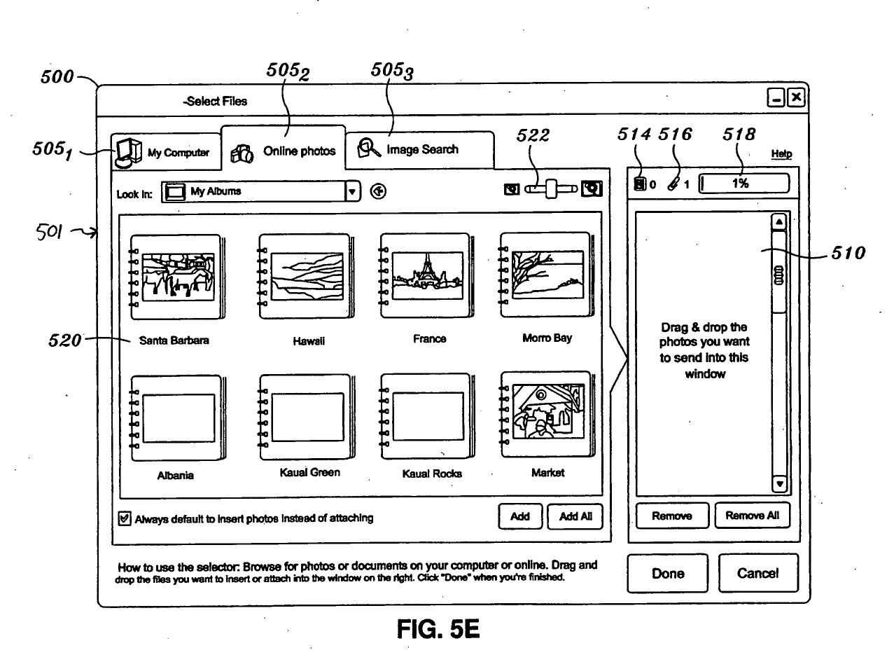

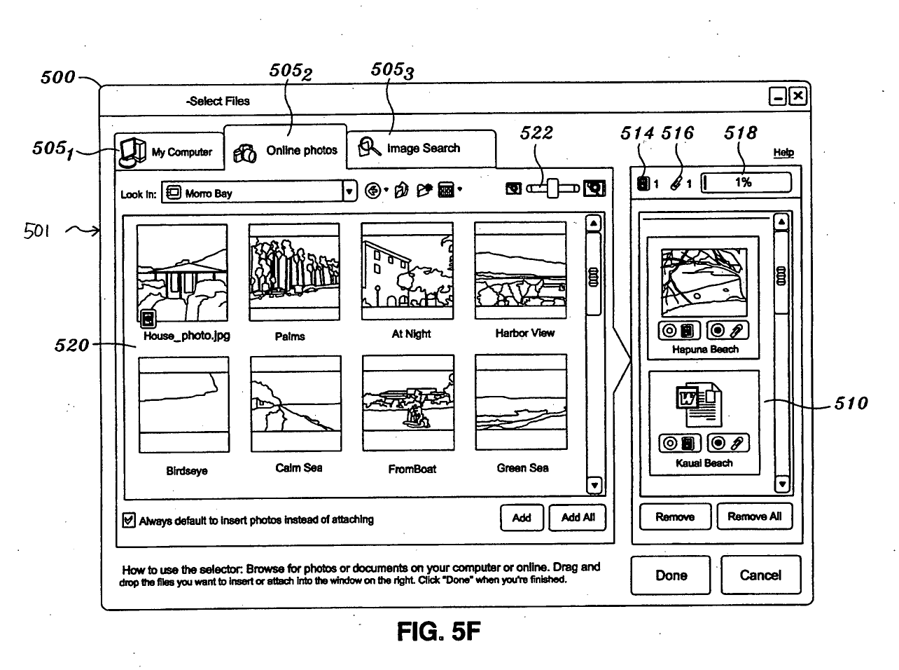

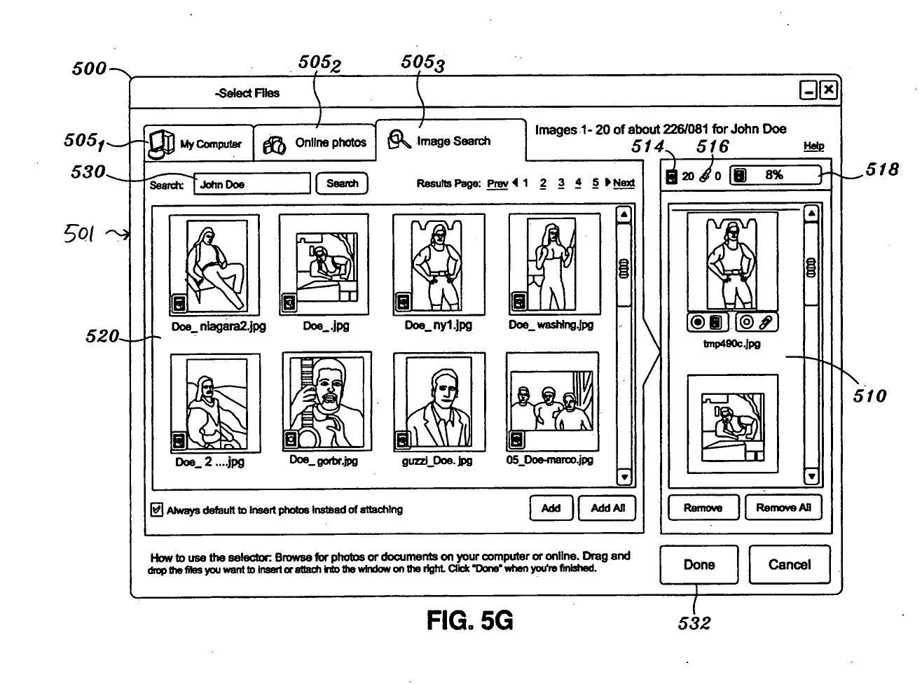

From inbox 305, a user desiring to share one or more image files, may select a “compose email” icon or menu option at block 405 to compose the email to which the one or more image files are to be associated. At this point, the user may compose an email in the typical fashion. FIG. 4B depicts one embodiment of a pop-up window usable to compose an email 407. If the user does not desire to attach or embed a file to the email 407, process 400 will simply continue to block 425 where, after the email 407 is sent, a delivery confirmation screen may be presented to the user. However, if the user does desire to attach an image file, one of icons 415 and 420 may be used to call up a file selection interface characterized by a pop-up window. In one embodiment, icon 415 may be used to call up a file selection interface for the photo embedding module discussed below with reference to FIG. 5A (e.g., shown as graphical user interface 500). As will be discussed in more detail below, icon 415 may be used to embed an image thumbnail and/or link information into an email without having to transfer the full image file. Icon 420, on the other hand, may be used to attach a non-image file, or any other file type that is stored on a user computer 40 using the traditional email attachment process. Alternatively, it should be understood that only one icon may be used for all attachment scenarios.

Once one of the attachment icons 415 or 420 has been selected by the user, a determination is made at block 430 as to whether the photo attachment module is installed on the user's computer (e.g., user computer 40). If so, the process 460 will continue to block 435 where, as discussed below, the attachment module's GUI 500 of FIG. 5A is displayed. If, on the other hand, the attachment module has not been installed on the user's computer, then process 400 will continue to decision block 440 where the user is prompted to install the attachment module. In one embodiment, the user may be presented with a typical file attachment dialog box, along with a prompt to install the photo attachment module. One such embodiment is depicted in FIG. 4C. In particular, section 445 of FIG. 4C enables the user to attach files in the typical fashion to the email 407 being composed (e.g., by browsing the computer's local hard drive). Section 450, on the other hand, prompts the user to learn more and/or install the attachment module. It should be appreciated that the pop-up dialog attachment window of FIG. 4C is but one embodiment and may have numerous other arrangements.

Referring back to FIG. 4A, if a user does not desire to install the attachment module, but rather attaches files in the typical fashion using section 445, for example, process 400 will continue to block 455 where the user-selected files are selected from a local storage location (e.g., local hard drive), and attached to the email 407. Once the email 407 is finished and sent, process 400 then terminates by presenting the user with a delivery confirmation screen at block 425. If, on the other hand, the user does desire to install the attachment module, then process 400 will proceed to block 460 where the installation process is commenced.

In one embodiment, the installation process comprises downloading and installing the photo attachment module in the form of Windows™ module and/or an ActiveX control module to the user's computer (e.g., user computer 40) over network 50. The Windows™ module may be used to generate the graphical user interfaces in a browser application, as described below with reference to FIGS. 5A-5G, while the ActiveX control module may be used to embed an ActiveX reference in an email to a remote online account. In one embodiment, this ActiveX reference is visually represented in an email as a thumbnailed image which corresponds to a full image file stored on a remote server. However, it should be appreciated that other operating system modules may similarly be used to generate the graphical user interfaces of FIGS. 5A-5G. In another embodiment, the attachment module may comprise a Firefox plugin, a Java program, or an XHTML component. As previously discussed, one aspect of the invention is to present the graphical user interfaces referenced above in a webmail environment using an Internet browser, such as Windows Internet Explorer™. A webmail account may then be used to compose an email message in a webmail environment without the use of an application program other than the browser itself.

FIGS. 5A-5G depict various Internet browser screenshots of a file selection interface 501 according to one example, shown here as part of graphical user interface (GUI) 500. Generally, GUI 500 (including file selection interface 501) is operable to attach and/or embed files into webmail correspondence, and in particular, as will be described in more detail below, GUI 500 is operable to select files from both local and remote sources for attaching or embedding into an email. In another example, GUI 500 is usable to embed an image thumbnail and/or related link information into an email without having to transfer the full image file as part of the email. The email recipient may then selectively download the corresponding full image files by selecting from the individual thumbnails and/or link information embedded in the email. It should of course be appreciated that the full image file may also be embedded into the body of the email, rather than being attached in the typical fashion.

Referring now specifically to FIG. 5A, depicted is a screenshot of one embodiment of a graphical user interface 500 for a photo attachment module, which may be used with various aspects described herein. In one embodiment, GUI 500 is generated by a Windows™ module executing on the user's computer (e.g., user computer 40). However, it should be appreciated that other operating system modules may similarly be used. In the embodiment of FIG. 5A, GUI 500 is presented in the standard Windows™ format with files being organized into tree-structured folders and subfolders. From GUI 500, a user may select an image file source by selecting one of tabs 505₁-505₃. One aspect of the invention is to provide a single interface which enables users to select image files from both local, as well as remote source such as an online storage account or the like. To that end, when tab 505₁ is selected, display panel 520 of GUI 500 is populated with the tree-structured folders and files as stored on the user's local computer system (e.g., mass storage 252). The user may then drill down through the tree-structured arrangement to select image files to insert into the email in progress. In addition, and as will be described below, when tab 505₂ is selected, display panel 520 may be populated with image files available from a remote storage account (e.g., from a Yahoo! Photos account or similar online storage system). Similarly, when tab 505₃ is selected, a search dialog box may be presented to the user for searching from available online third-party image sources (e.g., Internet picture search). Accordingly, from a single file selection interface 501, e.g., of GUI 500, a user may select files from local and remote sources for attachment or embedding within an email message.

In one embodiment, a user may select a folder or file by clicking on it, and then selecting the ‘add’ button 507. This operation would move the selected file (or folder) to queue 510. For example, in the embodiment of FIG. 5A, folder 512 has been selected and may be added to queue 510 by simply clicking on the ‘add’ button 507. Alternatively, GUI 500 may be equipped with the drag-and-drop functionality allowing users to select and drag files/folders into queue 510.

As files/folders are placed into queue 510, image file icon 514 and attachment icon 516 may be used to follow how many files, whether they be image files or otherwise, have been selected and placed in queue 510. In one embodiment, attachment icon 516 is used to keep track of the number of files that are placed in the queue 510 which are to be attached to the email (e.g., email 407) in the typical fashion. In another embodiment, or in addition to one or more of the previous embodiments, image file icon 514 may be used to track how many image thumbnails have been placed into the queue 510 which are to be embedded into the email. As mentioned previously, thumbnails and/or link information to the corresponding full sized image file may be embedded into an email so that the email recipient may selectively download individual files. In one embodiment, this link information is in the form of an ActiveX control reference to a remote online account. In addition, file size progress bar 518 may be used to keep track of the total storage space required for the selected files/folders. This may be useful, for example, where an email attachment size limit is being imposed.

Referring now to FIG. 5B, another embodiment of a screenshot for GUI 500 is depicted. In this embodiment, a user has drilled down the folder tree-structure to the file level. In particular, the contents of the folder named “Santa Barbara,” are presented in thumbnail view in display panel 520. Again, these are image files stored on a local storage device in a subfolder. A user may select one or more of these image files to attach to the email being composed (e.g., email 407) by either dragging and dropping them into queue 510, or using the previously-described ‘add’ button 507. Where no individual files have been selected, a user may place all of the files in the current folder into queue 510 by selecting the “add all” button 524. In another embodiment, slider 522 may be used to resize the thumbnailed images in display panel 520.

FIG. 5C is yet another embodiment of a screenshot of GUI 500. In this embodiment, four image files have been placed into the queue 510 for embedding into an email (e.g., email 407). In addition to being able to scroll down through the queue 510, image file icon 514 also indicates that four image files are in the queue 510, while progress bar 518 indicates that only 3% of the allowable attachment size is being consumed by the four image files to be embedded in email 407, for example.

Continuing to refer to FIG. 5C, users may also be given the opportunity to individually select how each queued image file will be appended to the email in progress (e.g., email 407). For example, using radio buttons 524, users can toggle between having the image files attached to the email in the typical fashion (e.g., by selecting the paper clip radio button), or by embedding the image file and/or link information into the body of the email (e.g., by selecting the image file icon).

In the embodiment of FIG. 5C, as each file in the display pane 520 is added to the queue, the thumbnail is updated with an attachment state icon 530 to reflect this fact. For example, each of the four thumbnails of display panel 520 have been added to the queue 510 as embedded image files rather than as typical attachments. As such, those four thumbnails are depicted with the attachment state icon 530 for embedded image files.

FIG. 5D depicts yet another embodiment of a screenshot of GUI 500. In this embodiment, the user had drilled down into a subfolder called “Recipes” and has added a non-image file to the queue 510 for attachment to email 407. Since the file in the queue 510 is a non-image file, the paper clip radio button is automatically selected and the image file icon of the radio buttons 524 is inactive. Moreover, the thumbnail of the attached non-image file is updated with the appropriate attachment state icon 530 (i.e., the paper clip attachment icon).

Unlike with FIGS. 5A-5D, FIG. 5E is an embodiment of a screenshot of GUI 500 in which tab 505₂ has been selected. By simply selecting the “online photos” tab (i.e., tab 505₂), a user can access a remote online account as if it were a local directory. It should be appreciated that the user may have to log in to the remote account by providing a username and/or password. In another embodiment, cookies or another authentication mechanism may be used to automatically log the user into their account.

Once the user is properly logged in, display panel 520 may be populated with the contents of the remote storage account (e.g., Yahoo! Photos account). It should be appreciated that the remote storage account may include any server that is accessible to the user's computer, either by communication link 30 or via network 50. Moreover, in the embodiment of FIG. 5E the available content used to populate the display panel 520 has been organized into “albums,” which function essentially the same as a tree-structured foldering system. By clicking on any of the albums in the display panel 520, the user would be able to access the individual image files contained therein. Even though the displayed albums and image files are not stored locally, a user need only drag-and-drop a desired file/album into the queue 510 to have the selected file/album embedded or attached to the email 407. In one embodiment, dragging-and dropping a file/album into the queue 510 while tab 505₂ is selected embeds a thumbnail of the image/album along with an ActiveX control reference to the online account. The recipient of the email may then view and/or download the full image file from the remote online account by clicking on the ActiveX reference.

FIG. 5F depicts a screenshot of another embodiment of GUI 500 in which the online photos tab is still selected (i.e., tab 505₂), and where the user has accessed the remotely stored album titled “Morro Bay.” As shown, the individual image files which comprise the Morro Bay album populate the display panel 520. From this point, the user may drag-and-drop any of the thumbnailed image files into the queue 510 to have them embedded or attached to the email 407. Once the image files are queued, the user may then use the radio buttons 524 to either attach the full sized image file to the email 407 in the traditional fashion, or embed the image file into the body of the email 407. While in one embodiment, the full sized image may be embedded into the email, in another embodiment a thumbnail of the full sized image file and/or link information to the full sized image file image may be embedded into the email 407. In this fashion, the recipient of the email 407, may simply click on the individual image files which they desire to download, which in the embodiment of FIG. 5F may be downloaded from the remote online account.

The embodiment of a screenshot of GUI 500 is depicted in FIG. 5G. In this embodiment, the user has selected tab 505₃, which corresponds to image content which is available online (e.g., via network 50). After selecting tab 505₃, a user may enter their search criteria into box. Based on the provided search criteria, an online search of available image files is performed, with the search results populating the display panel 520. As previously described, any of the individual search results may then be dragged into the queue 510 for eventual embedding or attaching to the email 407 being composed. Thus, as with locally stored image files (tab 505₁) and image files stored in a remote account (tab 505₂), image files posted on the Internet may all be accessed and integrated into electronic mail using a single interface (GUI 500).

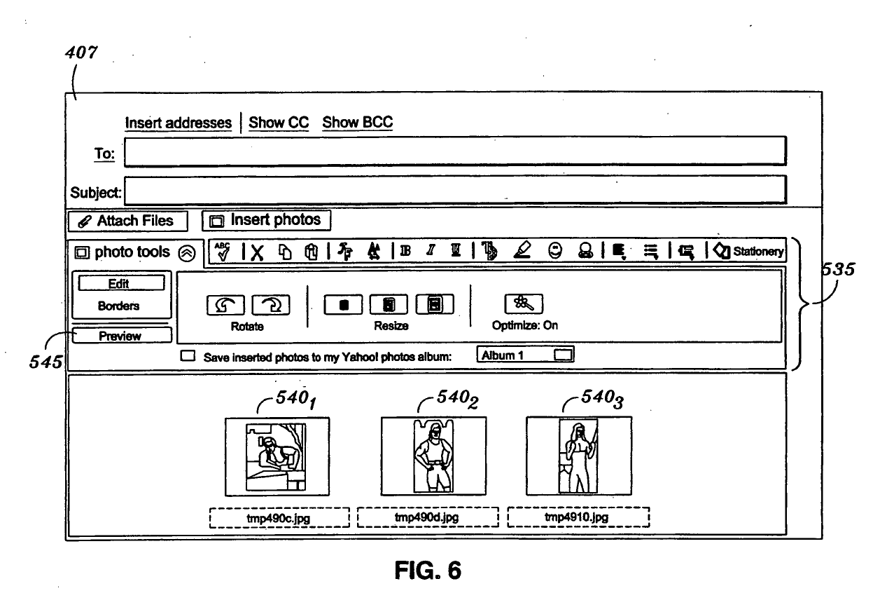

Once a user has completed the file attaching/embedding process, the user may exited the GUI 500 may clicking the ‘Done’ button 532. In one embodiment, this returns the user to the email 407 being composed. To that end, FIG. 6 depicts one embodiment of a screenshot of email 407 after three thumbnailed images (540₁-540₃) have been embedded. As mentioned above, thumbnailed images 540₁-540₃ may represent the full sized image being embedded into the email 407, or alternatively may be ActiveX references which are selectable by an email recipient desiring to download the full sized image file.

In another embodiment, once one or more image files have been embedded into an email, a user may be presented with photo tools 535 for editing the photos before sending them. In addition, depending on the source of the thumbnailed images 540₁-540₃, a user may be given options for saving the image files either to a local storage medium (e.g., mass storage 252), or to a remote photo storage account (e.g., Yahoo! Photos). In addition to being able to edit and/or save the embedded images, preview button 545 may be used to preview the email (including the embedded images) prior to sending.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A file selection interface for selecting a file for transfer within an email environment, the file selection interface comprising logic for:
displaying local files associated with a local source and remote files associated with a remote source;
enabling selection of at least one file of the displayed local files and remote files for transfer with an email message; and
initiating a process for transferring the at least one selected file with the email message.

2. The file selection interface of claim 1, further comprising logic operable to display the local files and remote files within a single graphical user interface.

3. The file selection interface of claim 1, wherein the file selection interface is displayed within a webmail environment.

4. The file selection interface of claim 1, wherein the remote source includes an online storage account.

5. The file selection interface of claim 1, furthering comprising logic for placing the at least one selected file into a queue of selected files.

6. The file selection interface of claim 1, wherein the local files and remote files are image files, and the file selection interface further comprises logic for initiating a process of embedding the selected file into a body of the email message.

7. The file selection interface of claim 6, wherein the at least one selected file is stored on a server, and wherein the embedding comprises inserting a reference link into the body of the email message to access the at least one selected file from the server.

8. The file selection interface of claim 1, further comprising logic for initiating a search of at least one online sources to display a list of online files, wherein files from the list of online files may be selected for transfer with an email message.

9. A method for selecting files for transfer with an email message, the method including:
displaying local files associated with a local source and remote files associated with a remote source within a file selection interface;
selecting at least one of the local files and remote files for transfer with an email message; and
initiating a process for transferring the at least one selected file from the displayed local files and remote files with the email message.

10. The method of claim 9, wherein the local files and remote files are displayed within a single interface.

11. The method of claim 9, wherein the file selection interface is displayed within a webmail environment.

12. The method of claim 9, wherein the remote source includes an online storage account.

13. The method of claim 9, furthering comprising placing the at least one selected file into a queue of selected files of the file selection interface.

14. The method of claim 9, wherein the local files and remote files are image files, and further comprising initiating a process of embedding the at least one selected file into a body of the email message.

15. The method of claim 14, wherein the at least one selected file is stored on a server, and wherein the embedding comprises inserting a reference link into the body of the email message to access the at least one selected file from the server.

16. The method of claim 9, further comprising initiating a search of at least one online source to display a list of online files, wherein files from the list of online files may be selected for transfer with the email message.

17. A computer readable medium encoded with computer readable program code, the computer readable medium comprising:
program code for displaying a file selection interface, the file selection interface displaying local files associated with a local source and remote files associated with a remote source;
program code for enabling a selection of at least one file of the local files and remote files for transfer with an email message; and
program code for initiating a transfer of the at least one file selected for transfer with the email message.

18. The computer readable medium of claim 17, further comprising program code operable to display the file selection interface within a browser application.

19. The computer readable medium of claim 17, further comprising program code operable to display the local files and remote files within a single interface.

20. The computer readable medium of claim 17, further comprising program code operable to display the file selection interface within a webmail environment.

21. The computer readable medium of claim 17, wherein the remote source includes an online storage account.

22. The computer readable medium of claim 17, furthering comprising program code for placing the selected file into a selected file queue of the file selection interface.

23. The computer readable medium of claim 17, wherein the local files and remote files are image files, and the computer readable medium further comprises program code for initiating a process of embedding the selected file into a body of the email message.

24. The computer readable medium of claim 23, wherein the selected file is stored on a server, and wherein the embedding comprises inserting a reference link into the body of the email message to access the selected file from the server.

25. The computer readable medium of claim 17, further comprising program code for initiating a search of at least one online source to display a list of online files, wherein files from the list of the at least one online source may be selected for transfer with an email message.
